(19) United States
(12) Patent Application Publication
(10) Pub. No.: US 2013/0084652 A1
(43) Pub. Date: Apr. 4, 2013

(54) Homogeneous Chemiluminescence Assay Methods with Increased Sensitivity

(71) Applicants: Nir Shapir, M.P. Misgav (IL); Michael Salvati, Minnetrista, MN (US); Jeff Todtleben, Prior Lake, MN (US); Hashem Akhavan-Tafti, Howell, MI (US); Richard S. Handley, Canton, MI (US)

(72) Inventors: Nir Shapir, M.P. Misgav (IL); Michael Salvati, Minnetrista, MN (US); Jeff Todtleben, Prior Lake, MN (US); Hashem Akhavan-Tafti, Howell, MI (US); Richard S. Handley, Canton, MI (US)

(73) Assignee: BECKMAN COULTER, INC., Brea, CA (US)

(21) Appl. No.: 13/641,476

(22) PCT Filed: May 13, 2011
(86) PCT No.: PCT/US11/36509

§ 371 Date: Dec. 13, 2012

Related U.S. Application Data
(60) Provisional application No. 61/334,850, filed on May 14, 2010.

(51) Int. Cl. G01N 21/76

(52) U.S. Cl. CPC G01N 21/76
USPC 436/501

(57) ABSTRACT

Methods are disclosed for determining an analyte in a medium suspected of containing the analyte. One method comprises treating a medium suspected of containing an analyte under conditions such that the analyte, if present, causes a photosensitizer and a chemiluminescent compound to come into close proximity. The photosensitizer generates singlet oxygen and activates the chemiluminescent compound when it is in close proximity. Non-specific signal generated by singlet oxygen not in proximity is reduced or suppressed using a singlet oxygen quencher (SOQ). The activated chemiluminescent compound subsequently produces light. The amount of light produced is related to the amount of analyte in the medium. Use of Noise Modulation Agents significantly improves signal-to-noise ratios and assay sensitivity. Compositions and kits are also disclosed.

### BACKGROUND

Specific binding assays are test methods for detecting the presence or amount of a substance and are based on the specific recognition and binding together of specific binding partners. Immunoassays are an example of a specific binding assay in which an antibody binds to a particular protein or compound. In this example an antibody is a member of a specific binding pair member. Nucleic acid binding assays are another type in which complementary nucleic acid strands are the specific binding pair. Specific binding assays constitute a broad and growing field of technology that enable the accurate detection of disease states, infectious organisms and drugs of abuse. Much work has been devoted over the past few decades to devise assays and assay methodology having the required sensitivity, dynamic range, robustness, broad applicability and suitability to automation.

Luminescent compounds, such as fluorescent compounds and chemiluminescent compounds, find wide application in the assay field because of their ability to emit light. For this reason, luminescers have been utilized as labels in assays such as nucleic acid assays and immunoassays described above. For example, a member of a specific binding pair is conjugated to a luminescer and various protocols are employed such one can relate the level of luminescence observed to a concentration or simply the presence of the analyte in the sample.

These specific binding assay methods can be grouped broadly into two categories. Homogeneous methods utilize an analyte-specific binding reaction to modulate or create a detectable signal without requiring a separation step between analyte-specific and analyte non-specific reactants. Heterogeneous formats rely on physical separation of analyte-bound detectably labeled specific binding partners from free (not bound to analyte) detectably labeled specific binding partners. Separation typically requires that critical reactants be immobilized onto some type of solid substrate so that some type of physical process can be employed, e.g. filtration, settling, agglomeration or magnetic separation, and typically also require wash steps to remove the free detectably labeled specific binding partners.

Particles, such as latex beads and liposomes, have also been utilized in assays. For example, in homogeneous assays an enzyme may be entrapped in the aqueous phase of a liposome labeled with an antibody or antigen. The liposomes are caused to release the enzyme in the presence of a sample and complement. Antibody- or antigen-labeled liposomes, having water soluble fluorescent or non-fluorescent dyes encapsulated within an aqueous phase or lipid soluble dyes dissolved in the lipid bilayer of the lipid vesicle, have also been utilized to assay for analytes capable of entering into an immunochemical reaction with the surface bound antibody or antigen. Detergents have been used to release the dyes from the aqueous phase of the liposomes.

U.S. Pat. No. 6,911,305, incorporated herein by reference, discloses a method of detecting polynucleotide analytes bound to a sensitizer or sensitizer-labeled probe on a first film. The film is contacted with a second film bearing an immobilized chemiluminescent precursor. Exciting the sensitizer in the sandwiched films produces singlet oxygen which reacts with the chemiluminescent precursor to produce a triggerable chemiluminescent compound on the second film. The triggerable chemiluminescent compound is reacted with a reagent to generate chemiluminescence on the second film for detecting the analyte. These methods do not rely on the specific binding reaction for bringing the reactants into contact; rather the second film serves as a reagent delivery device.

U.S. Pat. No. 6,406,913, incorporated herein by reference, discloses assay methods comprising treating a medium suspected of containing an analyte under conditions such that the analyte causes a photosensitizer and a chemiluminescent compound to come into close proximity. The photosensitizer generates singlet oxygen when irradiated with a light source; the singlet oxygen diffuses through a solution to and activates the chemiluminescent compound when it is in close proximity. The activated chemiluminescent compound subsequently produces light. The amount of light produced is related to the amount of analyte in the medium. In one embodiment, at least one of the photosensitizer or the chemiluminescent compound is associated with a suspendible particle, and a specific binding pair member is bound thereto.

These homogeneous assay formats utilizing singlet oxygen diffusion for selectivity of chemiluminescent compound activation relationship to analyte provide operational convenience and flexibility in automation compared to prior art assay techniques. Despite these advantages, additional improvements in assay design and performance remain a goal of assay developers. In particular, improvements in specific signal generation and reduction in background (e.g. non-specific signal) are desirable. The assay methods of the present disclosure address these needs by providing simple assay methods of improved or increased sensitivity.

### SUMMARY

Methods, reagents, kits and systems are disclosed for determining an analyte in a sample suspected of containing the analyte where all reagents are soluble in aqueous solution. One assay method includes treating a sample suspected of containing the analyte under conditions such that if the analyte is present, a sensitizer is brought into reactive configuration with a chemiluminescent compound to activate it. The reaction mixture including the sample is also treated with an agent to reduce signal not related to the analyte. Finally, the sample is subjected to conditions (either energy or a reactive compound) to cause the sensitizer to generate singlet oxygen for reaction with the chemiluminescent compound thereby producing light from the chemiluminescent compound to signal the presence of the analyte in the sample.

### DESCRIPTION

### I. Definitions

Alkyl—A branched, straight chain or cyclic hydrocarbon group containing from 1-20 carbons which can be substituted with 1 or more substituents other than H. Lower alkyl as used herein refers to those alkyl groups containing up to 8 carbons.

Analyte—A substance in a sample to be detected in an assay. One or more substances having a specific binding affinity to the analyte will be used to detect the analyte. The analyte can be a protein, a peptide, an antibody, or a hapten to which an antibody that binds it can be made. The analyte can be a nucleic acid or oligonucleotide which is bound by a complementary nucleic acid or oligonucleotide. The analyte can be any other substance which forms a member of a specific binding pair. Other exemplary types of analytes include drugs such as steroids, hormones, proteins, glycoproteins, mucoproteins, nucleoproteins, phosphoproteins, drugs of abuse, vitamins, antibacterials, antifungals, antivirals, purines, antineoplastic agents, amphetamines, azepine compounds, nucleotides, and prostaglandins, as well as metabolites of any of these drugs, pesticides and metabolites of pesticides, and receptors. Analyte also includes cells, viruses, bacteria and fungi.

Antibody—includes the full immunoglobulin as well as native and engineered fragments.

Aralkyl—An alkyl group substituted with an aryl group. Examples include benzyl, benzyhydryl, trityl, and phenylethyl.

Aryl—An aromatic ring-containing group containing 1 to 5 carbocyclic aromatic rings, which can be substituted with 1 or more substituents other than H.

Biological material—includes, for example, whole blood, anticoagulated whole blood, plasma, serum, tissue, animal and plant cells, cellular content, viruses, and fungi.

Chemiluminescent compound—A compound, which also may be referred to as a label, which undergoes a reaction so as to cause the emission of light, for example by being converted into another compound formed in an electronically excited state. The excited state may be either a singlet or triplet excited state. The excited state may directly emit light upon relaxation to the ground state or may transfer excitation energy to an emissive energy acceptor, thereby returning to the ground state. The energy acceptor is raised to an excited state in the process and emits light.

Chemiluminescent-labeled immobile specific binding partner (sbp)—a reactant in the assay mix that includes at least the following in a connected configuration: a) a specific binding partner (sbp) for an analyte, b) an chemiluminescent compound or label, and c) a solid phase.

Dose Response—Signal, such as chemiluminescent output from an assay reaction that is related to the amount of the analyte being determined in the sample.

Free radical trap (FRT)—refers to compounds which react readily with free radicals, typically to form a stable product compound. Representative free radical traps, sometimes referred to as spin traps, are aliphatic and aromatic nitrones such as phenyl t-butyl nitrone, PBN.

Heteroalkyl—An alkyl group in which at least one of the ring or non-terminal chain carbon atoms is replaced with a heteroatom selected from N, O, or S.

Heteroaryl—An aryl group in which one to three of the ring carbon atoms is replaced with a heteroatom selected from N, O, or S. Exemplary groups include pyridyl, pyrrolyl, thienyl, furyl, quinolyl and acridnyl groups.

Metastable species—generally, an excited state that is produced at a first site and migrates to a second site where it can transfer energy or react with a molecule at the second site. The metastable species may also be a reactive intermediate such as, for example, a free radical, a radical ion, nitrene, carbene, highly strained molecules such as trans-cyclohexene and α-lactones, trimethylene methane and the like, where the metastable species has a lifetime of less than ten milliseconds, typically less than one microsecond. The metastable species also includes, for example, singlet states such as singlet oxygen, triplet states, and dioxetanes including dioxetanones and dioxetane diones that have a lifetime of less than ten milliseconds, typically less than one microsecond. Triplet states are generally formed by combining an appropriate sensitizer such as, for example, pyrene with an energy acceptor such as an anthracene. For example, dibromoanthracene can act as an energy acceptor which assumes a triplet state. The triplet state can proceed to transfer its energy to another molecule and initiate a detectible photochemical reaction such as the production of light. Dioxetanes including dioxetanones and dioxetanediones are formed from reaction of active molecules with singlet oxygen or hydrogen peroxide. For example, appropriate oxalates and hydrogen peroxide form dioxetane diones. Enzymes such as horseradish peroxidase can generate radical cations or singlet oxygen that likewise are metastable and can react with another molecule to give a detectible signal.

Photosensitizer—a sensitizer for generation of singlet oxygen usually by excitation with light. The photosensitizer can be photoactivatable (e.g., dyes and aromatic compounds) or chemiactivated (e.g., enzymes and metal salts). When excited by light the photosensitizer is usually a compound comprised of covalently bonded atoms, usually with multiple conjugated double or triple bonds. The compound absorbs light in the wavelength range of 200-1100 nm, usually 300-1000 nm, preferably 450-950 nm, with an extinction coefficient at its absorbance maximum greater than 500 M⁻¹ cm⁻¹, preferably at least 5000 M⁻¹ cm⁻¹, more preferably at least 50,000 M⁻¹ cm⁻¹ at the excitation wavelength. The lifetime of an excited state produced following absorption of light in the absence of oxygen will usually be at least 100 nsec, preferably at least 1 μsec. In general, the lifetime must be sufficiently long to permit energy transfer to oxygen, which will normally be present at concentrations in the range of 10⁻⁵ to 10⁻³ M depending on the medium. The photosensitizer excited state will usually have a different spin quantum number (S) than its ground state and will usually be a triplet (S=1) when, as is usually the case, the ground state is a singlet (S=O). Preferably, the photosensitizer will have a high intersystem crossing yield. That is, photoexcitation of a photosensitizer will produce the long lived state (usually triplet) with an efficiency of at least 10%, desirably at least 40%, preferably greater than 80%. The photosensitizer will usually be at most weakly fluorescent under the assay conditions (quantum yield usually less that 0.5, preferably less that 0.1).

Photosensitizers that are to be excited by light will be relatively photostable and will not react efficiently with singlet oxygen. Several structural features are present in most useful photosensitizers. Most photosensitizers have at least one and frequently three or more conjugated double or triple bonds held in a rigid, frequently aromatic structure. They will frequently contain at least one group that accelerates intersystem crossing such as a carbonyl or imine group or a heavy atom selected from rows 3-6 of the periodic table, especially iodine or bromine, or they may have extended aromatic structures. Typical photosensitizers include acetone, benzophenone, 9-thioxanthone, eosin, 9,10-dibromoanthracene, methylene blue, metallo-porphyrins, such as hematoporphyrin, phthalocyanines, chlorophylls, rose bengal, buckminsterfullerene, etc., and derivatives of these compounds having substituents of 1 to 50 atoms for rendering such compounds more lipophilic or more hydrophilic and/or as attaching groups for attachment, for example, to an sbp member. Examples of other photosensitizers that may be utilized in the present invention are known to those of skill in the art, and are described, for example, in U.S. Pat. No. 6,406,913, incorporated herein by reference. In the methods described herein, the photosensitizers are preferably relatively non-polar to assure dissolution into a lipophilic member when the photosensitizer is incorporated into a solid support, including, for example, a bead, particle, or the like.

Particles—particles of at least about 20 nm and not more than about 20 microns, usually at least about 40 nm and less than about 10 microns, preferably from about 0.10 to 2.0 microns diameter, normally having a volume of less than 1 picoliter. The particle may be organic or inorganic, swellable or non-swellable, porous or non-porous, having any density, but preferably of a density approximating water, generally from about 0.7 to about 1.5 g/ml, preferably suspendible in water, and composed of material that can be transparent, partially transparent, or opaque. The particles may or may not have a charge, and when they are charged, they are preferably negative. The particles may be solid (e.g., polymer, metal, glass, organic and inorganic such as minerals, salts and diatoms), oil droplets (e.g., hydrocarbon, fluorocarbon, silicon fluid), or vesicles (e.g., synthetic such as phospholipid or natural such as cells and organelles). The particles may be latex particles or other particles comprised of organic or inorganic polymers; lipid bilayers, e.g., liposomes; phospholipid vesicles; oil droplets; silicon particles; metal sols; cells; and dye crystallites.

The organic particles will normally be polymers, either addition or condensation polymers, which are readily dispersible in the assay medium. The organic particles will also be adsorptive or functionalizable so as to bind at their surface, either directly or indirectly, an sbp member and to bind at their surface or incorporate within their volume a photosensitizer or a chemiluminescent compound.

The particles can be derived from naturally occurring materials, naturally occurring materials which are synthetically modified and synthetic materials. Natural or synthetic assemblies such as lipid bilayers, e.g., liposomes and non-phospholipid vesicles, are preferred. Among organic polymers of particular interest are polysaccharides, particularly cross-linked polysaccharides, such as agarose, which is available as SEPHAROSE® (Pharmacia Biotech), dextran, available as SEPHADEX® (Pharmacia Biotech) and SEPHACRYL® (Pharmacia Biotech), cellulose, starch, and the like; addition polymers, such as polystyrene, polyacrylamide, homopolymers and copolymers of derivatives of acrylate and methacrylate, particularly esters and amides having free hydroxyl functionalities including hydrogels, and the like. Inorganic polymers include silicones, glasses, available as Bioglas, and the like. Sols include gold, selenium, and other metals. Particles may also be dispersed water insoluble dyes such as porphyrins, phthalocyanines, etc., which may also act as photosensitizers. Particles may also include diatoms, cells, viral particles, magnetosomes, cell nuclei and the like. Where the particles are commercially available, the particle size may be varied by breaking larger particles into smaller particles by mechanical means, such as grinding, sonication, agitation, etc.

The particles will usually be polyfunctional or capable of being polyfunctionalized or capable of being bound to a specific binding partner (sbp) member, photosensitizer, or chemiluminescent compound through specific or non-specific covalent or non-covalent interactions. A wide variety of functional groups is available or can be incorporated. Exemplary functional groups include carboxylic acids, aldehydes, amino groups, cyano groups, ethylene groups, hydroxyl groups, mercapto groups and the like. When covalent attachment of a sbp member, chemiluminescent compound or photosensitizer to the particle is employed, the manner of linking is well known and is amply illustrated in the literature. The process is described in detail in U.S. Pat. No. 6,406,913 and in references cited therein.

The photosensitizer and/or chemiluminescent compound can be chosen to dissolve in or noncovalently bind to the surface of the particles. In this case these compounds will preferably be hydrophobic to reduce their ability to dissociate from the particle and thereby cause both compounds to associate with the same particle. This possibly can be further reduced by utilizing particles of only one composition that are associated with either the photosensitizer or chemiluminescent compound or by using two types of particles that differ in composition so as to favor association of the photosensitizer with one type of particle and association of the chemiluminescent compound with the other type of particle.

The number of photosensitizer or chemiluminescent molecules associated with each particle will on the average usually be at least one and may be sufficiently high that the particle consists entirely of photosensitizer or chemiluminescer molecules. The preferred number of molecules will be selected empirically to provide the highest signal to background in the assay. In some cases this will be best achieved by associating a multiplicity of different photosensitizer molecules to particles. Usually, the photosensitizer or chemiluminescent compound to specific binding partner (sbp) member ratio in the particles should be at least 1, preferably at least 100 to 1, and most preferably over 1,000 to 1.

Sample—A mixture containing or suspected of containing an analyte to be measured in an assay. Analytes include for example proteins, peptides, nucleic acids, hormones, antibodies, drugs, and steroids Typical samples which can be used in the methods of the disclosure include bodily fluids such as blood, which can be anticoagulated blood as is commonly found in collected blood specimens, plasma, serum, urine, semen, saliva, cell cultures, tissue extracts and the like. Other types of samples include solvents, seawater, industrial water samples, food samples and environmental samples such as soil or water, plant materials, eukaryotes, bacteria, plasmids, viruses, fungi, and cells originated from prokaryotes.

Sensitizer—a compound which when stimulated or induced to react cause another compound or species to undergo a chemical reaction. Sensitizer includes photosensitizers which are induced by irradiation with light to form a reactive excited state. Sensitizer also includes compounds which can undergo a chemical reaction to produce a metastable species such as singlet oxygen.

Specific binding pair member—also known as specific binding partner (sbp); the specific binding partner is a molecule, including biological molecules, having a specific binding affinity for another substance (e.g., analyte. Two specific binding partners for an analyte, preferably with different binding sites on the analyte, are referred to as a specific binding pair.

NMA, (Noise Modulation Agent)—A compound provided in an assay reaction mixture of the present disclosure such that non-specific signal or background signal is reduced in a greater amount than the analyte-specific signal generated from the chemiluminescent production reaction of the assay reaction mixture. In the methods described herein, the NMA is a compound or mixture (such as, for example, a singlet oxygen quencher (SOQ)) capable of interfering with the reaction between the metastable species and the signal producing compound.

Solid support—a material at least 1 micron in size having a surface upon which assay components are immobilized. Materials can be in the form of particles, microparticles, nanoparticles, metal colloids, fibers, sheets, beads, membranes, filters and other supports such as test tubes, microwells, chips, glass slides, and microarrays.

Soluble, solubility, solubilize—The ability or tendency of one substance to blend uniformly with another. In the present disclosure, solubility and related terms generally refer to the property of a solid in a liquid, for example NMA in an aqueous buffer. Solids are soluble to the extent they lose their crystalline form and become molecularly or ionically dissolved or dispersed in the solvent (e.g. liquid) to form a true solution. In contrast: two-phase systems where one phase consists of small particles (including microparticles or colloidal sized particles) distributed throughout a bulk substance, whether stabilized to deter precipitation or unstabilized.

Substituted—Refers to the replacement of at least one hydrogen atom on a group by a non-hydrogen group. It should be noted that in references to substituted groups it is intended that multiple points of substitution can be present unless clearly indicated otherwise.

Reaction Vessel—A vessel or apparatus for containing the sample and other components of an assay according to the present invention. Included are, for example, test tubes of various sizes and shapes, and microwell plates.

### II. Modes for Carrying Out the Invention

The present disclosure provides homogeneous assay methods, in particular homogeneous assay methods using chemiluminescent detection of analytes after binding of a chemiluminescent-labeled specific binding partner and a sensitizer-labeled specific binding partner conjugate and the analyte. Homogeneous assays and methods are performed without separating free specific binding partners from specific binding partners bound in complexes.

The present disclosure provides rapid and simple homogeneous assays for detecting the presence, location, or amount of substances by means of specific binding pair reactions. The assays require the use of a chemiluminescent compound connected with a first specific binding partner (“chemiluminescent-labeled sbp”), a sensitizer compound conjugated to a second specific binding partner (“sensitizer-labeled sbp”), and a noise modulation agent (“NMA”), an enhancer, in a solution phase.

The present assay methods differ from other homogeneous assay methods by not requiring specialized constructs, namely labeled specific binding pair members that are designed with a detectable component that is inactivated or only able to generate the particular detectable signal after it is bound in a complex with another component. In contrast to the assay system of the present disclosure, other homogenous assay systems are complex, difficult, or expensive to prepare because they require such specialized components. The present assays afford a simpler, more flexible approach to assay design and development and permit more ready application to a wide variety of analytes. The present assay methods differ from conventional heterogeneous or separation-based assay methods by not utilizing a separation step or process to differentiate free specific binding partners from specific binding partners bound in complexes. By use of the present assay methods which avoid separations, conduct of assays is simplified, assay times can be reduced and automation is facilitated.

In assay methods of the present disclosure a chemiluminescent-labeled sbp, a sensitizer-labeled sbp, and noise modulation agent (“NMA”) are brought together with a sample. In one embodiment when the analyte recognized by the sbp members is present in the sample, chemiluminescent-labeled sbp and sensitizer-labeled sbp each bind to different areas of the analyte to form a complex. In another embodiment when the analyte present in the sample is recognized by one of the sbp members, the other sbp member is prevented from binding in a complex. This is typically achieved by providing one sbp member as a conjugate of the analyte or analyte-analog and either the sensitizer or chemiluminescent compound while the other sbp member is a conjugate of a substance having binding affinity for the analyte and the other of the sensitizer or chemiluminescent compound. The latter format enables competitive binding assays to be performed.

The specific signal related to analyte is generated and detection begins upon subjecting the assay mixture to conditions for generating a metastable species for undergoing a reaction with the chemiluminescent compound. In another embodiment a chemiluminescent-labeled analog of the analyte is provided for use in a competitive assay format. Analyte and chemiluminescent-labeled analog competitively bind to sensitizer-labeled sbp. Complexes of chemiluminescent-labeled analog and sensitizer-labeled sbp can be pre-formed and the analyte added to displace the labeled analog in one embodiment of a competitive binding assay. In another embodiment chemiluminescent-labeled analog, the analyte, and sensitizer-labeled sbp can be mixed together without pre-forming binding complexes. The specific signal related to analyte is generated and detection begins upon subjecting the assay mixture to conditions for generating a metastable species for undergoing a reaction with the chemiluminescent compound. Signal is inversely related to analyte concentration in this assay format.

As a result of the specific binding partners binding due to the analyte, a sensitizer is brought into operable proximity to a chemiluminescent compound so that it is effective to produce a metastable species in proximity to the chemiluminescent compound. Reaction of the metastable species with the chemiluminescent compound results in the generation of light. By operable proximity is meant that the chemiluminescent compound and sensitizer are close enough, including and up to physical contact, that the metastable species then generated is generated at a distance from the chemiluminescent compound within its diffusion lifetime. By this is meant that within the lifetime of the metastable species, it is capable of reaching to the chemiluminescent compound by diffusion through the assay medium and through the medium of any suspendible particles used. Excess amounts of sensitizer-labeled specific binding partner and/or chemiluminescent-labeled specific binding partner may be provided to the system in relation to the amount needed to determine analyte concentration. “Excess metastable species”, or metastable species not in proximity with the binding complex formed by sensitizer-labeled sbp and chemiluminescent-labeled sbp, may be present and will lead to an increase in non-specific signal. In the presence of excess metastable species, the chemiluminescent detection reaction may not provide a useful correlation, or at best, a very limited correlation of signal with analyte. According to conventional wisdom, the generation or presence of excess metastable species ordinarily causes assay failure due to excess non-specific signal or limits the sensitivity of the assay. The non-specific signal generated by excess metastable species can be reduced to acceptable levels by diluting the analyte. However, the sensitivity of the assay is also reduced.

Surprisingly, it has been found that non-specific signal associated with excess metastable species can reduced with a noise modulation agent. In the present methods, non-specific background signal due to excess metastable species, such as singlet oxygen, for example, can be suppressed through the use of singlet oxygen quenchers (SOQ). The inventors have discovered that excellent discrimination results from the addition of certain NMA compounds. By use of the NMA, the ratio of signal produced by reaction between chemiluminescent label and sensitizer label in the reactive binding complex to signal from the labels present, but not in such a complex, is dramatically improved and can be achieved without dilution of the analyte.

The function of the NMA in improving assay sensitivity is understood in reference to Scheme 1. Multiple different combinations of free (e.g., not bound to analyte) and complexed (e.g., analyte bound) chemiluminescent-labeled sbp (“CLSBP”) and sensitizer-labeled specific binding pair (“SLSBP”) may possibly contribute to the observed chemiluminescent signal. Four proposed reaction schemes are listed below:

1 Bound-SLSBP+Bound-CLSBP+metastable species in proximity→Specific Signal
2 Bound-SLSBP+Free-CLSBP+excess metastable species→Non-specific Signal
3 Free-SLSBP+Bound-CLSBP+excess metastable species→Non-specific Signal
4 Free-SLSBP+Free-CLSBP+excess metastable species→Non-specific Signal
As shown in the list above, four different types of chemiluminescer-sensitizer pairs can react in the reaction mix and interact with the metastable species to generate a detectable signal, but only the first type produces a signal that is relatable to the amount of analyte in an assay. The NMA achieves its function by selectively inhibiting, suppressing or quenching the amount of signal from reactions 2-4 in relation to that from reaction 1.

In embodiments of the present invention, there are provided methods of assaying analytes of interest in a sample by means of specific binding reactions involving the analyte and specific binding partners (sbp) for the analyte wherein one specific binding partner is labeled with a sensitizer compound which may be a photosensitizer, particularly one which is capable of generating singlet oxygen. Another specific binding partner for the analyte is labeled with a chemiluminescent compound. Binding of the labeled sbp's due to the analyte causes formation of labeled complexes. The chemiluminescent compound undergoes a chemiluminescent reaction when it interacts with the metastable species formed. The chemiluminescence that results is related to the amount of the analyte in the sample. Subjecting the sensitizer label to conditions for generating a metastable species, typically generates a large amount of the metastable species in excess of what is required for reacting with the chemiluminescent compound. Only some of the metastable species is in proximity to the binding complex and therefore able to interact with the complex to produce the chemiluminescent reaction. The excess amount of metastable species may generate a significant “background” signal such that no useful dose-response relationship can be elicited. In order to be able to perform a homogeneous nonseparation assay when all of the reaction components necessary for chemiluminescent signal generation are present both in the binding complex and in free or unbound form, some means must be provided to discriminate bound and unbound labeled sbp's, other than a physical separation. The present methods do not require or use specially designed labeled binding partners that are incapable of undergoing the signal-producing reaction unless they are brought into a binding complex.

In assay methods embodied by the invention, the necessary discrimination of labeled sbp members bound in a complex with the analyte from free, unbound labeled sbp members is achieved by providing a noise modulation agent (NMA) to the reaction solution. Addition of an effective amount of the NMA to the reaction solution causes the signal from the bound labeled sbp members (Signal) to exceed background signal, including any signal contribution from excess metastable species, or metastable species that is not in close proximity to the binding complex, to a greater degree than occurs in the absence of NMA. In the methods described herein, the NMA a species or compound capable of inhibiting, suppressing or quenching the metastable species, a singlet oxygen quencher (SOQ). The NMA can also be a compound capable of competitively reacting with singlet oxygen without producing chemiluminescence. When the improvement of the relationship of Signal to Background is achieved, the usefulness of the assays increases, including higher levels of detection sensitivity.

One aspect of the present invention is a method for determining an analyte. The present invention, unlike previous homogenous assay methods, does not require dilution of the sample or reaction mixture in order to achieve an acceptable signal-to-noise ratio. The method comprises treating a medium suspected of containing an analyte under conditions such that the analyte, if present, affects the amount of a photosensitizer and a chemiluminescent compound that can come into close proximity wherein the short-lived metastable species, i.e. singlet oxygen generated by the photosensitizer can react with the chemiluminescent compound prior to its spontaneous decay. The method further comprises measuring the intensity of luminescence produced by the chemiluminescent compound. The intensity of luminescence produced is related to the amount of analyte in the medium. The chemiluminescent compound is capable of activation by singlet oxygen, and the photosensitizer catalyzes the formation of singlet oxygen usually in response to photoexcitation followed by energy transfer to molecular oxygen. Often a surface will be brought into close proximity with the photosensitizer and chemiluminescent compound, wherein the surface will preferably be the surface of suspendible particles. The product formed by the activation of the chemiluminescent compound decomposes, preferably spontaneously, with emission of light.

The invention is predicated on an analyte causing or inhibiting molecules of the photosensitizer and the chemiluminescent compound to be closer to each other than their average distance in the bulk solution of the assay medium. This partitioning will depend upon the amount of analyte present in the sample to be analyzed. The photosensitizer molecules that do not become associated with the chemiluminescent compound produce singlet oxygen that is unable to reach the chemiluminescent compound before undergoing decay in the aqueous medium. This “excess” singlet oxygen produces a significant non-specific background signal relative to the signal from the actual analyte, making detection of the analyte difficult, and significantly impairing the sensitivity of the assay. The use of an NMA is, therefore, preferred. The NMA interferes with the “excess” singlet oxygen, thereby reducing, quenching or suppressing the background signal from the singlet oxygen, leading to an improvement in signal-to-noise ratio and a consequent increase in the sensitivity of the assay. Therefore, the assays described herein provide a method for detecting and measuring a wide variety of analytes in a simple, efficient, reproducible manner, employing simple equipment for measuring the amount of light produced during the reaction, and with significant improvement in signal-to-noise and assay sensitivity, which can be achieved without dilution of the analyte or reaction mixture.

No matter how the photosensitizer and chemiluminescent compound are bound, it is critical that neither compound is capable of dissociating from its sbp member and becoming associated with the sbp member bound to the other member of the photosensitizer and chemiluminescent compound pair during the course of the assay. Thus, dissociation of these compounds from their respective sbp members must be slow relative to the time required for the assay.

The chemiluminescent compound may be bound to a sbp member that is capable of binding directly or indirectly to the analyte or to an assay component whose concentration is affected by the presence of the analyte. The term “capable of binding directly or indirectly” means that the designated entity can bind specifically to the entity (directly) or can bind specifically to a specific binding pair member or to a complex of two or more sbp members which is capable of binding the other entity (indirectly).

The surface generally has an sbp member bound to it. Preferably, the chemiluminescent compound is associated with the surface, usually within a suspendible particle. This sbp member is generally capable of binding directly or indirectly to the analyte or a receptor for the analyte. When the sbp members associated with the photosensitizer and the chemiluminescent compound are both capable of binding to the analyte, a sandwich assay protocol results. When one of the sbp members associated with the photosensitizer or chemiluminescent compound can bind both the analyte and an analyte analog, a competitive assay protocol can result. The attachment to a surface or incorporation in a particle of the chemiluminescent compound is governed generally by the same principles described above for the attachment to, or the incorporation into, a particle of the photosensitizer.

The photosensitizer is usually caused to activate the chemiluminescent compound by irradiating the medium containing the above reactants. The medium must be irradiated with light having a wavelength with energy sufficient to convert the photosensitizer to an excited state and thereby render it capable of activating molecular oxygen to singlet oxygen. The excited state for the photosensitizer capable of exciting molecular oxygen is generally a triplet state which is more than about 20, usually at least 23, Kcal/mol more energetic than the photosensitizer ground state. Preferably, the medium is irradiated with light having a wavelength of about 450 to 950 nm although shorter wavelengths can be used, for example, 230 to 950 nm. The luminescence produced may be measured in any convenient manner such as photographically, visually or photometrically to determine the amount thereof, which is related to the amount of analyte in the medium.

Although it will usually be preferable to excite the photosensitizer by irradiation with light of a wavelength that is efficiently absorbed by the photosensitizer, other means of excitation may be used as for example by energy transfer from an excited state of an energy donor such as a second photosensitizer. When a second photosensitizer is used, wavelengths of light can be used which are inefficiently absorbed by the photosensitizer but efficiently absorbed by the second photosensitizer. The second photosensitizer may be bound to an assay component that is associated, or becomes associated, with the first photosensitizer, for example, bound to a surface or incorporated in the particle having the first photosensitizer. When a second photosensitizer is employed it will usually have a lowest energy triplet state at higher energy than the lowest energy triplet state of the first photosensitizer. The 632.6 nm emission line of a helium-neon laser is an inexpensive light source for excitation. Photosensitizers with absorption maxima in the region of about 620 to about 700 nm are particularly useful in the present invention.

The binding reactions in an assay for the analyte will normally be carried out in an aqueous medium at a moderate pH, generally that which provides optimum assay sensitivity. Preferably, the activation of the photosensitizer will also be carried out in an aqueous medium. However, when a separation step is employed, non-aqueous media such as, e.g., acetonitrile, acetone, toluene, benzonitrile, etc. and aqueous media with pH values that are very high, i.e., greater than 10.0, or very low, i.e., less than 4.0, usually very high, can be used. As explained above, the assay can be performed either without separation (homogeneous) or with separation (heterogeneous) of any of the assay components or products.

The aqueous medium may be solely water or may include from 0.01 to 80 volume percent of a cosolvent but will usually include less than 40% of a cosolvent when an sbp member is used that is a protein. The pH for the medium of the binding reaction will usually be in the range of about 4 to 11, more usually in the range of about 5 to 10, and preferably in the range of about 6.5 to 9.5. When the pH is not changed during the generation of singlet oxygen the pH will usually be a compromise between optimum binding of the binding members and the pH optimum for the production of signal and the stability of other reagents of the assay. When elevated pHs are required for signal production, a step involving the addition of an alkaline reagent can be inserted between the binding reaction and generation of singlet oxygen and/or signal production. Usually the elevated pH will be greater than 10, usually 10-14. For heterogenous assays non-aqueous solvents may also be used as mentioned above, the main consideration being that the solvent not react efficiently with singlet oxygen.

Various buffers may be used to achieve the desired pH and maintain the pH during an assay. Illustrative buffers include borate, phosphate, carbonate, tris, barbital and the like. The particular buffer employed is not critical to this invention, but in an individual assay one or another buffer may be preferred.

Moderate temperatures are normally employed for carrying out the binding reactions of proteinaceous ligands and receptors in the assay and usually constant temperature, preferably, 25° C. to 40° C., during the period of the measurement. Incubation temperatures for the binding reaction will normally range from about 5° C. to 45° C., usually from about 15° C. to 40° C., more usually 25° C. to 40° C. Where binding of nucleic acids occur in the assay, higher temperatures will frequently be used, usually 20° C. to 90° C., more usually 35° C. to 75° C. Temperatures during measurements, that is, generation of singlet oxygen and light detection, will generally range from about 20° C. to 100° C., more usually from about 25° C. to 50° C., more usually 25° C. to 40° C.

The concentration of analyte which may be assayed will generally vary from about 10⁻⁴ to below 10⁻¹⁶ M, more usually from about 10⁻⁶ to 10⁻¹⁴ M. Considerations, such as whether the assay is qualitative, semiquantitative or quantitative, the particular detection technique the concentration of the analyte of interest, and the maximum desired incubation times will normally determine the concentrations of the various reagents.

In competitive assays, while the concentrations of the various reagents in the assay medium will generally be determined by the concentration range of interest of the analyte, the final concentration of each of the reagents will normally be determined empirically to optimize the sensitivity of the assay over the range. That is, a variation in concentration of the analyte which is of significance should provide an accurately measurable signal difference.

The concentration of the sbp members will depend on the analyte concentration, the desired rate of binding, and the degree that the sbp members bind nonspecifically. Usually, the sbp members will be present in at least the lowest expected analyte concentration, preferably at least the highest analyte concentration expected, and for noncompetitive assays the concentrations may be 10 to 10⁶ times the highest analyte concentration but usually less than 10⁻⁴ M, preferably less than 10⁻⁶ M, frequently between 10⁻¹¹ and 10⁻⁷ M. The amount of photosensitizer or chemiluminescent compound associated with a sbp member will usually be at least one molecule per sbp member and may be as high as 10⁵, usually at least 10-10⁴ when the photosensitizer or chemiluminescent molecule is incorporated in a particle.

While the order of addition may be varied widely, there will be certain preferences depending on the nature of the assay. The simplest order of addition is to add all the materials simultaneously. Alternatively, the reagents can be combined wholly or partially sequentially. When the assay is competitive, it will often be desirable to add the analyte analog after combining the sample and an sbp member capable of binding the analyte. Optionally, an incubation step may be involved after the reagents are combined, generally ranging from about 30 seconds to 6 hours, more usually from about 2 minutes to 1 hour before the sensitizer is caused to generate singlet oxygen and the light emission is measured.

In a homogeneous assay after all of the reagents have been combined, they can be incubated, if desired. Then, the combination is irradiated, resulting in the generation of singlet oxygen and a detectible chemilumiscent signal. This signal is measured and is related to the amount of the analyte in the sample tested. The amounts of the reagents of the invention employed in a homogeneous assay depend on the nature of the analyte. Generally, the homogeneous assay of the present invention exhibits an increased sensitivity over known assays. This advantage results primarily because of the improved signal to noise ratio obtained in the present method, through the use of free radical traps (FRT) or singlet oxygen quenchers (SOQ) as noise modulation agents (NMA).

### Chemiluminescent-Labeled Sbp

The methods require the use of a chemiluminescent compound connected with a first specific binding partner (“chemiluminescent-labeled sbp”). In the assays and methods of the present disclosure, the chemiluminescent labeling compound is immobilized to a solid surface, such as a particle, bead, multiwell plate, or membrane, filter, test tube, dipstick, or pipet tip as is found in other affinity assays and methods.

The chemiluminescent-labeled sbp includes a chemiluminescent label compound and a member of a specific binding pair.

In some embodiments, a chemiluminescent-labeled sbp includes one or more chemiluminescent label compounds.

In some embodiments, a chemiluminescent-labeled sbp includes one or more copies of a member of a specific binding pair.

In some embodiments, a chemiluminescent label compound is directly connected to one or more copies of a member of a specific binding pair. In some other embodiments, one or more chemiluminescent label compounds are directly connected to one copy of a member of a specific binding pair. Direct connections, also referred to as direct-labeled; include covalent binding interactions, ionic binding interactions, and hydrophobic interactions. In one embodiment the chemiluminescent label is covalently linked to a specific binding partner for the analyte.

In some embodiments, a chemiluminescent label compound is indirectly connected to one or more copies of a member of a specific binding pair. In some other embodiments, one or more chemiluminescent label compounds are indirectly connected to one copy of a member of a specific binding pair. Indirect connections include one or more auxiliary substances in addition to a chemiluminescent label compound and a member of a specific binding pair.

The auxiliary substances are soluble in aqueous solution. Chemiluminescent-labeled sbp's which include one or more auxiliary substances are soluble in aqueous solution.

In various embodiments, auxiliary substances include soluble proteins (e.g. streptavidin, avidin, neutravidin, biotin, cationized BSA, fos, jun, keyhole limpet hemocyanin “KLH”, immunoglobulins and fragments or portions thereof, whether native or engineered, soluble synthetic dendrimers (e.g., PAMAM), soluble synthetic polymers (e.g. polyacrylicacid “PAA”), soluble natural polymers (e.g., polysaccharides such as functionalized dextrans, amino-dextran, oligonucleotides, proteins, and any combinations thereof), liposomes, micelles, and vesicles, as well as combinations of one or more of soluble synthetic polymers, soluble natural polymers, and soluble proteins (e.g. IgG/Biotin/streptavidin/PAA). Other auxiliary substances that are soluble in aqueous solution and functionalizable for attachment to one or more chemiluminescent label compounds and/or sbp's are envisioned for use in the disclosed methods and assays.

In some embodiments the auxiliary substance to which the chemiluminescent label is covalently linked is a protein or peptide. Exemplary soluble proteins include albumins, avidins, streptavidin, avidin, alpha-helix proteins, fos, jun, keyhole limpet hemocyanin “KLH”, immunoglobulins and fragments or portions thereof, whether native or engineered, and any combinations thereof. In one embodiment, the auxiliary substance is a universal antibody, such as IgG, wherein the chemiluminescent label is covalently linked to the universal antibody in a manner to maintain its binding affinity for an analyte specific capture antibody. In another chemiluminescent-labeled sbp embodiment, the chemiluminescent compound is connected to one or more sbp's via a biotin-streptavidin or biotin-neutravidin linkage. Chemiluminescent-labeled sbp's incorporating streptavidin-biotin, or equivalent linkages, may for example provide the specific binding partner as a biotin conjugate where the chemiluminescent compound is a streptavidin conjugate. Alternative arrangements of biotin-streptavidin and similar linkages are generally known. Alternatively chemiluminescent-labeled sbp's incorporating streptavidin-biotin, or equivalent linkages, may utilize the linkage for attachment of sbp or chemiluminescent compounds to one or more additional auxiliary substances.

In another embodiment an auxiliary substance to which the chemiluminescent label is covalently linked is a synthetic polymer. Assay formats using polymeric auxiliaries for connecting the chemiluminescent compound can connect to the specific binding partner for the analyte by covalent linkage, as biotin-avidin conjugate, or by indirect attachment through a universal capture component such as a species specific immunoglobulin.

In select embodiments, the chemiluminescent-labeled sbp includes an auxiliary substance selected from polysaccharides or soluble self-assembling proteins. In some embodiments, chemiluminescent-labeled sbp includes a polysaccharide such as amino-dextran or carboxyl-dextran. In some such embodiments, a polysaccharide, such as amino-dextran or carboxyl-dextran, has an average molecular weight in the range of 10 kDa to 500 kDa, and in other embodiments, has an average molecular weight in the range of 25-150 kDa. In a further embodiment, a chemiluminescent-labeled sbp includes a polysaccharide, such as amino-dextran or carboxyl-dextran having an average molecular weight in the range of 50-100 kDa. In a yet further embodiment a chemiluminescent-labeled sbp includes a polysaccharide, such as amino-dextran or carboxyl-dextran having an average molecular weight of 70 kDa.

In many embodiments, the average diameter of the chemiluminescent-labeled sbp is in the inclusive range of 5 nM to 800 nM. In select embodiments, incorporating soluble proteins, or other soluble natural polymers or soluble synthetic polymers, or combinations thereof, the average diameter of the chemiluminescent-labeled sbp is in the inclusive range of 200 nM to 600 nM, in some further embodiments, in the inclusive range of 300 nM to 50 0 nM.

### Sensitizer-Labeled Sbp

The methods require the use of a sensitizer compound connected with a first specific binding partner (“sensitizer-labeled sbp”). In the assays and methods of the present disclosure, the sensitizer compound is not immobilized to a solid surface, such as a particle, multiwell plate, or membrane, filter, test tube, dipstick, or pipet tip as is found in other affinity assays and methods.

The sensitizer-labeled sbp includes an sensitizer label compound and a member of a specific binding pair.

In some embodiments, an sensitizer-labeled sbp includes one or more sensitizer compounds.

In some embodiments, an sensitizer-labeled sbp includes one or more copies of a member of a specific binding pair.

In some embodiments, a sensitizer compound is directly connected to one or more copies of a member of a specific binding pair. In some other embodiments, one or more sensitizer label compounds are directly connected to one copy of a member of a specific binding pair. Direct connections, also referred to as direct labeled, include covalent binding interactions, ionic binding interactions, and hydrophobic interactions. In one embodiment the sensitizer label is covalently linked to a specific binding partner for the analyte.

In some embodiments, a sensitizer compound is indirectly connected to one or more copies of a member of a specific binding pair. In some other embodiments, one or more sensitizer compounds are indirectly connected to one copy of a member of a specific binding pair. Indirect connections include auxiliary substances in addition to a a member of a specific binding pair.

The auxiliary substances are generally soluble in aqueous solution. Sensitizer-labeled sbp's which include one or more auxiliary substances are soluble in aqueous solution. In various embodiments, auxiliary substances include soluble proteins (e.g. streptavidin, avidin, neutravidin, biotin, cationized BSA, fos, jun, keyhole limpet hemocyanin “KLH”, immunoglobulins and fragments or portions thereof, whether native or engineered, and any combinations thereof), soluble synthetic dendrimers (e.g., PAMAM), soluble synthetic polymers (e.g. polyacrylicacid “PAA”), soluble natural polymers (e.g., polysaccharides such as dextran, oligonucleotides, proteins, and any combinations thereof), liposomes, micelles, and vesicles, as well as combinations of one or more of soluble synthetic polymers, soluble natural polymers, and soluble proteins (e.g. IgG/Biotin/streptavidin/PAA). Other auxiliary substances that are soluble in aqueous solution and functionalizable for attachment to one or more sensitizer label compounds and/or sbp's are envisioned for use in the disclosed methods and assays.

In some embodiments the auxiliary substance to which the sensitizer label is covalently linked is a protein or peptide. Exemplary soluble proteins include albumins, avidins, streptavidin, avidin, alpha-helix proteins, fos, jun, keyhole limpet hemocyanin “KLH”, immunoglobulins and fragments or portions thereof, whether native or engineered, and any combinations thereof. In one embodiment, the auxiliary substance is a universal antibody, such as IgG, wherein the sensitizer label is covalently linked to the universal antibody in a manner to maintain its binding affinity for an analyte specific capture antibody. In another sensitizer-labeled sbp embodiment, the sensitizer compound is connected to one or more sbp's via a biotin-streptavidin linkage. Sensitizer-labeled sbp's incorporating streptavidin-biotin, or equivalent linkages, may for example provide the specific binding partner as a biotin conjugate where the sensitizer compound is a streptavidin conjugate. Alternative arrangements of biotin-streptavidin and similar linkages are generally known. Alternatively sensitizer-labeled sbp's incorporating streptavidin-biotin, or equivalent linkages, may utilize the linkage for attachment of sbp or sensitizer compounds to one or more additional auxiliary substances.

In another embodiment an auxiliary substance to which the sensitizer label is covalently linked is a synthetic polymer. Assay formats using polymeric auxiliaries for connecting the sensitizer compound can connect to the specific binding partner for the analyte by covalent linkage, non-covalent linkage, or by indirect attachment through a universal capture component such as a species specific immunoglobulin or biotin-avidin conjugation.

In select embodiments, the sensitizer-labeled sbp includes an auxiliary substance selected from polysaccharides or soluble self-assembling proteins. In some embodiments, an sensitizer-labeled sbp includes a polysaccharide such as amino-dextran or carboxyl-dextran. In some such embodiments, a polysaccharide, such as amino-dextran or carboxyl-dextran, has an average molecular weight in the range of 10 kDa to 500 kDa, or in other embodiments has an average molecular weight in the range of 25 kDa to 150 kDa. In a further embodiment, a chemiluminescent-labeled sbp includes a polysaccharide, such as amino-dextran or carboxyl-dextran having an average molecular weight in the range of 50-100 kDa. In a yet further embodiment a chemiluminescent-labeled sbp includes a polysaccharide, such as amino-dextran or carboxyl-dextran having an average molecular weight of 70 kDa.

In most embodiments, the average molecular weight of the sensitizer-labeled sbp is in the inclusive range of 200 kDa to 3000 kDa. In some embodiments, the average molecular weight of the sensitizer-labeled specific binding pair is typically 350 kDa to 1500 kDa.

### Sensitizer Labels

In addition to the photosensitizers described above, sensitizers useful in this invention are also intended to include other substances and compositions that can produce metastable species such as singlet oxygen with or, less preferably, without activation by an external light source. Thus, for example, molybdate (MoO_{4.}²⁻) salts and chloroperoxidase and myeloperoxidase plus bromide or chloride ion (Kanofsky, J. Biol. Chem. (1983) 259 5596) have been shown to catalyze the conversion of hydrogen peroxide to singlet oxygen and water. Either of these compositions can, for example, be included in particles to which is bound an sbp member and used in the assay method wherein hydrogen peroxide is included as an ancillary reagent, chloroperoxidase is bound to a surface and molybdate is incorporated in the aqueous phase of a liposome. Also included within the scope of the invention as sensitizers are compounds which on excitation by heat, light, or chemical activation will release a molecule of singlet oxygen. The best known members of this class of compounds includes the arene endoperoxides such as 1,4-biscarboxyethyl-1,4-naphthalene endoperoxide, 9,10-diphenylanthracene-9,10-endoperoxide and 5,6,11,12-tetraphenyl naphthalene 5,12-endoperoxide. Heating or direct absorption of light by these compounds releases singlet oxygen.

### Noise Modulation Agents (NMA)

The noise modulation agents of the present invention are compounds that when included in an assay reaction mixture as described herein, interfere with the specific binding pair such that the resulting signal from the analyte-bound labeled sbp members exceeds background signal by a significantly greater degree than occurs in the absence of the NMA. In the present methods, NMA are compounds that inhibit, suppress or quench the metastable species generated by the sensitizer, thereby reducing the background signal caused by “excess” metastable species and improving the sensitivity of the assay. In the present methods, the NMA are singlet oxygen quenchers (SOQ).

One or more noise modulation agents are present in reaction methods at concentration between 10⁻⁶ M and 10⁻¹ M, frequently between 10⁻⁶ M and 10⁻² M, often between 10⁻⁵ M and 10⁻³ M, sometimes between 10⁻⁵ M and 10⁻⁴ M. In some embodiments, a noise modulation agent is present between 5×10⁻⁶ M and 5×10⁻⁴M in reactions according to the present methods. In still further embodiments, a noise modulation agent is present between 5×10⁻⁵ M and 5×10⁻⁴ M in reactions according to the present methods.

The noise modulation agent can be supplied as a separate reagent or solution at a higher concentration than is intended in the reaction solution. In this embodiment, a measured amount of the working solution is dosed into the reaction solution to achieve the desired reaction concentration. In another embodiment the noise modulation agent is combined into a solution containing one or more of the labeled sbp members. In another embodiment the noise modulation agent is provided as a component of the reagent comprising the reactive compound, where a reactive compound is used rather than energy to produce the metastable species.

The degree to which the noise modulation agent improves the signal-to-background or signal-to-noise ratio will vary depending on the identity of the compound and the concentration at which it is used, among other factors. The degree can be framed in terms of an improvement factor in which the signal:background ratio of an assay at a particular analyte concentration wherein the assay is performed with the noise modulation agent is compared to the signal:background ratio of an assay at the same analyte concentration without the noise modulation agent. An improvement factor >1, or between about 0.5 and 1, or between about 0.4 and 1, or between about 0.3 and 1, or between about 0.2 and 1, is a gauge of an improved assay and evidence of a beneficial effect of the noise modulation agent. In embodiments of the invention improvement factors of at least 2, such as at least 5 and including at least 10, or at least 50 are achieved. It will be seen in reference to the example below, that improvement factors can vary within an assay as a function of the analyte concentration. For example, improvement factors may increase as analyte concentration increases. In another embodiment the variation in improvement factor across a concentration may result in a more linear calibration curve, i.e. plot of chemiluminescence intensity vs. analyte concentration.

In the methods described herein, the NMA is a species or compound capable of interfering with the metastable species, such as, for example, singlet oxygen in the reaction mixture. In an embodiment, the NMA is a compound that competes with the chemiluminescent compound for reaction with singlet oxygen. In an embodiment, the NMA is a singlet oxygen quencher (SOQ).

The SOQs quench singlet oxygen either by photophysical quenching or by chemical reaction. SOQs that operate by photophysical quenching include, without limitation, tocopherols, ascorbate, carotenoids (such as β-carotene, lycopene and the like, for example), certain amino acids (such as proline, for example), tertiary amines (such as diazabicyclo[2.2.2]octane or DABCO, for example), azides (such as sodium azide, for example), certain proteins (such as thioredoxin, for example), platinum group metal colloids (as described in US 2007/0090153, incorporated herein by reference), amino-amide compounds (such as lidocaine, for example).

SOQs that operate by chemical reaction include, without limitation, methyl piperidines (such as 2,2,6,6-tetramethylpiperidines (TEMP)), vitamin D, dienes and longer conjugated polyenes (including cyanine dyes), electron-rich alkenes (such as enol ethers, enamines, and vinyl sulfides), guanine and the like. When a singlet oxygen reactive compound is to be used as SOQ, it is to be understood that it is acting as a competitive reactant to the chemiluminescent compound for consuming the singlet oxygen. It is preferable that the competing compound, especially when it is an electron-rich alkene not also form a chemiluminescent product. Less desirably is the case where the reaction product is chemiluminescent but at a different wavelength.

### Chemiluminescent Compounds

Chemiluminescent compounds in the practice of the present disclosure are compounds that chemically react with singlet oxygen to form an unstable intermediate that decomposes with the simultaneous or subsequent emission of light. Emission typically occurs spontaneously without heating or other energy addition, and without addition of a catalyst, energy acceptor or other ancillary reagents to cause decomposition and light emission from the intermediate formed by reaction of the chemiluminescent compound with singlet oxygen.

Preferred chemiluminescent compounds are usually electron rich compounds that react with singlet oxygen, frequently with formation of unstable intermediates such as dioxetanes or dioxetanones. Exemplary of such compounds are enol ethers, enamines, 9-alkylidenexanthans, 9-alkylidene-N-alkylacridans, aryl vinyl ethers, dioxenes, thioxenes, arylimidazoles and lucigenin as are generally known in the art of chemiluminescence.

The chemiluminescent compounds of interest emit within the wavelength range of 250 to 1200 nm, typically emitting at wavelengths above 300 nanometers and usually above 400 nm. Compounds that alone or together with a fluorescent molecule emit light at wavelengths beyond the region where serum components absorb light will be of particular use in the present invention. The fluorescence of serum drops off rapidly above 500 nm and becomes relatively unimportant above 550 nm. Therefore, when the analyte is in serum, chemiluminescent compounds that emit light above 550 nm, preferably above 600 nm are of particular interest. In order to avoid autosensitization of the chemiluminescent compound, it is preferable that the chemiluminescent compounds do not absorb light used to excite the photosensitizer. Since it will generally be preferable to excite the sensitizer with light wavelengths longer than 500 nm, it will therefore be desirable that light absorption by the chemiluminescent compound be very low above 500 nm.

Enol ethers of use in this invention generally have the structure:

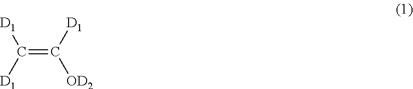

wherein the D₁'s are taken independently and are selected from the group consisting of H and substituents of 1 to 50 atoms, preferably, aryl, hydroxyaryl, aminoaryl, t-alkyl, H, alkoxy, heteroaryl, etc., and may be taken together with one or both of the carbon atoms to form a ring such as a cycloalkene, adamantylidene, 7-norbornylidene and the like, and D₂ is preferably alkyl or aryl. Exemplary enol ethers, by way of illustration and not limitation, are 2,3-diaryl-4,5-dihydrodioxenes:

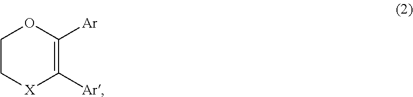

where X═O,S, or ND₂ and Ar and Ar′ are aryl including substituted aryl wherein at least one substituent is present as amino, ether or hydroxyl group.

Vinyl sulfides of use in this invention generally include the above mentioned enol ethers wherein the oxygen atom is replaced by a sulfur atom.

Enamines of use in this invention generally have the structure:

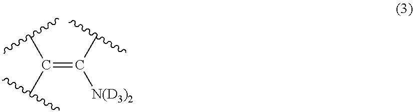

wherein D₃ may be independently alkyl or aryl and the remaining substituents on the olefin are selected from the group consisting of H and substituents of 1 to 50 atoms, preferably aryl, hydroxyaryl, aminoaryl, t-alkyl, H, alkoxy, heteroaryl, etc.
9-Alkylidene-N-alkylacridans generally have the structure:

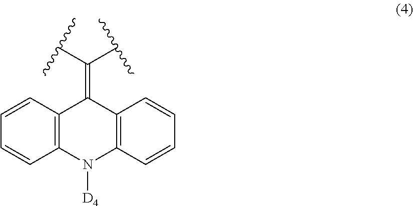

wherein D₄ is alkyl and the remaining substituents on the olefin are selected from the group consisting of H and substituents of 1 to 50 atoms, preferably, phenyl, aryl, alkoxyaryl, aminoaryl, t-alkyl, H, alkoxy, heteroaryl, etc., and may be taken together to form a ring such as, for example, adamantyl, cyclopentyl, 7-norbornyl, and the like.
Dioxetanes formed by the reaction of singlet oxygen with a chemiluminescent compound have the general structure of formula 5 where the substituents on the carbon (C) atoms are those present on the corresponding olefin:

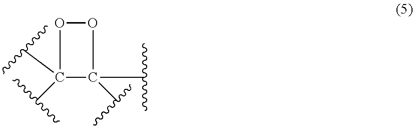 [SMILES: *C1(*)OOC1(*)*]

some of which decompose spontaneously, others by heating and/or by catalysis usually by an electron rich energy acceptor, with the emission of light. For some cases the dioxetane is spontaneously converted to a hydroperoxide whereupon basic pH is required to reform the dioxetane and permit decomposition and light emission.

Another family of chemiluminescent compounds is 2,3-dihydro-1,4-phthalazinediones. The most popular compound is luminol, which is the 5-amino compound. Other members of the family include substituted 6-amino, 5-amino-6,7,8-trimethoxy and the dimethylamino[ca]benz analog. These compounds are oxidized by singlet oxygen in a multistep reaction that results in decomposition with formation of a phthalate derivative and light emission.

Another family of chemiluminescent compound is Alkyl Thoxenes, for example C-8 Thioxene, below

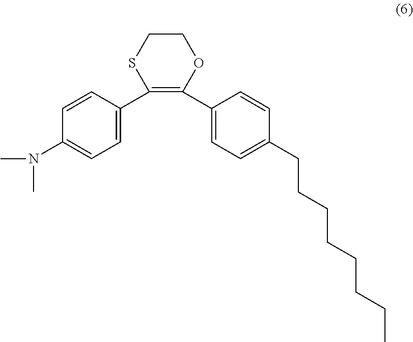 [SMILES: CCCCCCCCc1ccc(C2=C(c3ccc(N(C)C)cc3)SCCO2)cc1]

Another family of chemiluminescent compounds is the 2,4,5-triphenylimidazoles, with lophine as the common name for the parent compound. Chemiluminescent analogs include para-dimethylamino and -methoxy substituents.
The next group of chemiluminescent compounds includes bis arylene compounds including the bis-9,9′-acridylidene and the 10,10′-dimethyl derivative thereof described by Singer, J. Org. Chem. 41:2685 (1976), lucigenin, and bis-9,9′-xanthylidine.
Other chemiluminescent compounds that satisfy the requirements given above may be found in European Patent Application 0,345,776.

In one embodiment a group of chemiluminescent label compounds comprise an acridan ketenedithioacetal (AK) having formula 7

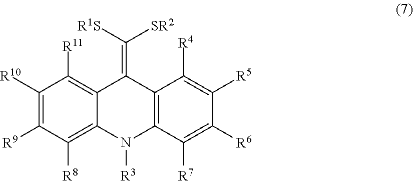

wherein R¹, R² and R³ are organic groups containing from 1 to 50 non-hydrogen atoms, and each of R⁴-R¹¹ is hydrogen or a non-interfering substituent.

The groups R¹ and R² in the compound of formula 7 can be any organic group containing from 1 to about 50 non hydrogen atoms selected from C, N, O, S, P, Si and halogen atoms which allows light production. By the latter is meant that when a compound of formula 7 undergoes a reaction of the present disclosure, an excited state product compound is produced and can involve the production of one or more chemiluminescent intermediates. The excited state product can emit the light directly or can transfer the excitation energy to a fluorescent acceptor through energy transfer causing light to be emitted from the fluorescent acceptor. In one embodiment R¹ and R² are selected from substituted or unsubstituted alkyl, substituted or unsubstituted alkenyl, substituted or unsubstituted alkynyl, substituted or unsubstituted aryl, and substituted or unsubstituted aralkyl groups of 1-20 carbon atoms. When R¹ or R² is a substituted group, it can be substituted with 1-3 groups selected from carbonyl groups, carboxyl groups, tri(C₁-C₈ alkyl)silyl groups, a SO₃⁻ group, a OSO₃⁻² group, glycosyl groups, a PO₃⁻ group, a OPO₃⁻² group, halogen atoms, a hydroxyl group, a thiol group, amino groups, quaternary ammonium groups, and quaternary phosphonium groups.

The group R³ is an organic group containing from 1 to 50 non-hydrogen atoms selected from C, N, O, S, P, Si and halogen in addition to the necessary number of H atoms required to satisfy the valences of the atoms in the group. In one embodiment R³ contains from 1 to 20 non-hydrogen atoms. In another embodiment the organic group is selected from the group consisting of alkyl, substituted alkyl, substituted or unsubstituted alkenyl, substituted or unsubstituted alkynyl, substituted or unsubstituted aryl, and substituted or unsubstituted aralkyl groups of 1-20 carbon atoms. In another embodiment groups for R³ include substituted or unsubstituted C₁-C₄ alkyl groups, phenyl, substituted or unsubstituted benzyl groups, alkoxyalkyl, carboxyalkyl and alkylsulfonic acid groups. When R³ is a substituted group, it can be substituted with 1-3 groups selected from carbonyl groups, carboxyl groups, tri(C₁-C₈ alkyl)silyl groups, a SO₃⁻ group, a OSO₃⁻² group, glycosyl groups, a PO₃⁻ group, a OPO₃⁻² group, halogen atoms, a hydroxyl group, a thiol group, amino groups, quaternary ammonium groups, and quaternary phosphonium groups. The group R³ can be joined to either R⁷ or R⁸ to complete a 5 or 6-membered ring. In the compounds of formula 7, the groups R⁴-R¹¹ each are independently H or a substituent group which permits the excited state product to be produced and generally contain from 1 to 50 atoms selected from C, N, O, S, P, Si and halogens. Representative substituent groups which can be present include, without limitation, alkyl, substituted alkyl, aryl, substituted aryl, aralkyl, alkenyl, alkynyl, alkoxy, aryloxy, halogen, amino, substituted amino, carboxyl, carboalkoxy, carboxamide, cyano, and sulfonate groups. Pairs of adjacent groups, e.g., R⁴-R⁸ or R⁸-R⁶, can be joined together to form a carbocyclic or heterocyclic ring system comprising at least one 5 or 6-membered ring which is fused to the ring to which the two groups are attached. Such fused heterocyclic rings can contain N, O or S atoms and can contain ring substituents other than H such as those mentioned above. In one embodiment R⁴-R¹¹ are selected from hydrogen, halogen and alkoxy groups such as methoxy, ethoxy, t-butoxy and the like. In another embodiment a group of compounds has one of R⁸, R⁶, R⁹ or R¹⁰ as a halogen and the other of R⁴-R¹¹ are hydrogen atoms.

Substituent groups can be incorporated in various quantities and at selected ring or chain positions in the acridan ring in order to modify the properties of the compound or to provide for convenience of synthesis. Such properties include, e.g., chemiluminescence quantum yield, rate of reaction with the enzyme, maximum light intensity, duration of light emission, wavelength of light emission and solubility in the reaction medium. Specific substituents and their effects are illustrated in the specific examples below, which, however, are not to be considered limiting the scope of the disclosure in any way. For synthetic expediency compounds of formula 7 desirably have each of R⁴ to R¹¹ as a hydrogen atom.

In another embodiment a group of compounds have formula 8 wherein each of R⁴ to R¹¹ is hydrogen. The groups R¹, R² and R³ are as defined above.

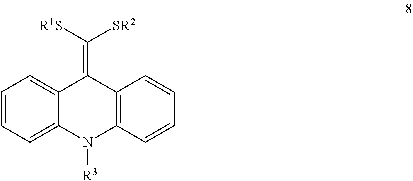

In an embodiment a labeling compound has formula 9, where LRG represents a linking group with reactive group for attachment to an specific binding partner, or solid surface.

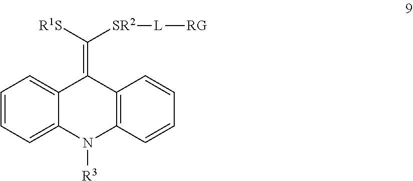

In another embodiment the chemiluminescent compounds comprises a chemiluminescent acridan enol derivative of formula V below wherein R¹ is selected from alkyl, alkenyl, alkynyl, aryl, and aralkyl groups of 1-20 carbon atoms any of which can be substituted with 1-3 groups selected from carbonyl groups, carboxyl groups, tri(C₁-C₈ alkyl)silyl groups, a SO₃⁻ group, a OSO₃⁻² group, glycosyl groups, a PO₃⁻ group, a OPO₃⁻² group, halogen atoms, a hydroxyl group, a thiol group, amino groups, quaternary ammonium groups, or quaternary phosphonium groups, wherein X is selected from C₁-C₈ alkyl, aryl, aralkyl groups, alkyl or aryl carboxyl groups having from 1-20 carbon atoms, tri(C₁-C₈ alkyl)silyl groups, a SO₃⁻ group, glycosyl groups and phosphoryl groups of the formula PO(OR′)(OR″) wherein R′ and R″ are independently selected from C₁-C₈ alkyl, cyanoalkyl, aryl and aralkyl groups, trialkylsilyl groups, alkali metal cations, alkaline earth cations, ammonium and trialkylphosphonium cations, wherein Z is selected from O and S atoms, wherein R⁶ is selected from substituted or unsubstituted C₁-C₄ alkyl, phenyl, benzyl, alkoxyalkyl and carboxyalkyl groups, wherein R⁷⁻¹⁴ are each hydrogen or 1 or 2 substituents are selected from alkyl, alkoxy, hydroxy, and halogen and the remaining of R⁷⁻¹⁴ are hydrogen

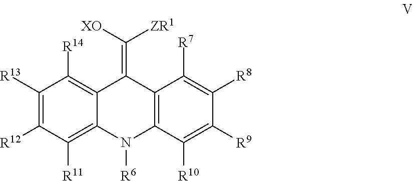

In another embodiment the chemiluminescent compounds is a chemiluminescent compound of formula VI below wherein R¹ is selected from alkyl, alkenyl, alkynyl, aryl, and aralkyl groups of 1-20 carbon atoms any of which can be substituted with 1-3 groups selected from carbonyl groups, carboxyl groups, tri(C₁-C₈ alkyl)silyl groups, a SO₃⁻ group, a OSO₃⁻² group, glycosyl groups, a PO₃⁻ group, a OPO₃⁻² group, halogen atoms, a hydroxyl group, a thiol group, amino groups, quaternary ammonium groups, or quaternary phosphonium groups, wherein X is selected from C₁-C₈ alkyl, aryl, aralkyl groups, alkyl or aryl carboxyl groups having from 1-20 carbon atoms, tri(C₁-C₈ alkyl)silyl groups, a SO₃⁻ group, glycosyl groups and phosphoryl groups of the formula PO(OR′)(OR″) wherein R′ and R″ are independently selected from C₁-C₈ alkyl, cyanoalkyl, aryl and aralkyl groups, trialkylsilyl groups, alkali metal cations, alkaline earth cations, ammonium and trialkylphosphonium cations, wherein Z¹ and Z² are each selected from O and S atoms and wherein R² and R³ are independently selected from hydrogen and C₁-C₈ alkyl.

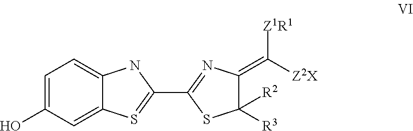

Where long wave length emission from the chemiluminescent compound is desired, a long wavelength emitter such as a pyrene, bound to the chemiluminescent compound can be used. Alternatively, a fluorescent molecule can be included in the medium containing the chemiluminescent compound. Preferred fluorescent molecules will be excited by the activated chemiluminescent compound and emit at a wavelength longer than the emission wavelength of the chemiluminescent compound, usually greater that 550 nm. It is usually also desirable that the fluorescent molecules do not absorb at the wavelengths of light used to activate the photosensitizer. Examples of useful dyes include rhodamine, ethidium, dansyl, Eu(fod)₃, Eu(TTA)₃, Ru(bpy)₃⁺⁺ (wherein bpy=2,2′-dipyridyl, etc. In general these dyes act as acceptors in energy transfer processes and preferably have high fluorescent quantum yields and do not react rapidly with singlet oxygen. They can be incorporated into particles simultaneously with the incorporation of the chemiluminescent compound into the particles. The electron rich olefins generally have an electron donating group in conjugation with the olefin:

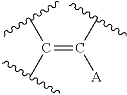

wherein A is an electron donating group such as, for example, N(D)₂, OD, p-[C₆H₄N(D)₂]₂, furanyl, n-alkylpyrrolyl, 2-indolyl, etc., where D can, for example, be alkyl or aryl, and either bound directly to the olefinic carbon or bound by the intermediacy of other conjugated double bonds, substitutents of 1 to 50 atoms, which may be taken together to form one or more rings, which are fused or unfused, e.g., cycloalkyl, phenyl, naphthyl, anthracyl, acridanyl, adamantyl, and so forth.

Linking Group (L).

A linking group will vary depending upon the nature of the molecules, i.e., photosensitizer, chemiluminescent compound, sbp member or molecule associated with or part of a particle, being connected. Functional groups that are normally present or are introduced on a photosensitizer or chemiluminescent compound or sbp member will be employed for linking these materials to an sbp member or a particle such as a lipophilic component of a liposome or oil droplet, latex particle, silicon particle, metal sol, or dye crystallite. The linking group used in the present disclosure can be a bond, an atom, divalent groups and polyvalent groups, or a straight, or branched chain of atoms some of which can be part of a ring structure. The substituent usually contains from 1 to about 50 non-hydrogen atoms, more usually from 1 to about 30 non-hydrogen atoms. In another embodiment atoms comprising the chain are selected from C, O, N, S, P, Si, B, and Se atoms. In another embodiment atoms comprising the chain are selected from C, O, N, P and S atoms. The number of atoms other than carbon in the chain is normally from 0-10. Halogen atoms can be present as substituents on the chain or ring. Typical functional groups comprising the linking substituent include alkylene, arylene, alkenylene, ether, peroxide, carbonyl as a ketone, ester, carbonate ester, thioester, or amide group, amine, amidine, carbamate, urea, imine, imide, imidate, carbodiimide, hydrazino, diazo, phosphodiester, phosphotriester, phosphonate ester, thioether, disulfide, sulfoxide, sulfone, sulfonate ester, sulfate ester, and thiourea groups. In another embodiment the group is an alkylene chain of 1-20 atoms terminating in a —CH₂—, —O—, —S—, —NH—, —NR—, —SiO—, —C(═O)—, —OC(═O)—, —C(═O)O—, —SC(═O)—, —C(═O)S—, —NRC(═O)—, —NRC(═S)—, or —C(═O)NR— group, wherein R is C₁₋₈ alkyl. In another embodiment the linking group is a poly(alkylene-oxy) chain of 3-30 atoms terminating in a —CH₂—, —O—, —S—, —NH—, —NR—, —SiO—, —C(═O)—, —OC(═O)—, —C(═O)O—, —SC(═O)—, —C(═O)S—, —NRC(═O)—, —NRC(═S)—, or —C(═O)NR— group, wherein R is C₁₋₈ alkyl.

The linking group or molecule being connected may also include a functional or reactive group that is an atom or group whose presence facilitates bonding to another molecule by covalent attachment or physical forces. In some embodiments, attachment of a molecule to another molecule will involve loss of one or more atoms from the reactive group for example when the reactive group is a leaving group such as a halogen atom or a tosylate group and the chemiluminescent labeling compound is covalently attached to another compound by a nucleophilic displacement reaction.

In one embodiment RG is an N-hydroxysuccinimide (NHS) ester group, where the group will react with a moiety on the substance, typically an amine group, in the process splitting the ester C—O bond, releasing N-hydroxysuccinimide and forming a new bond between an atom of the substance (N if an amine group) and the carbonyl carbon of the labeling compound. In another embodiment RG is a hydrazine moiety, —NHNH₂. As is known in the art this group reacts with a carbonyl group in a substance to be labeled to form a hydrazide linkage.

In other embodiments, attachment of a molecule to another molecule by covalent bond formation will involve reorganization of bonds within the reactive group as occurs in an addition reaction such as a Michael addition or when the reactive group is an isocyanate or isothiocyanate group. In still other embodiments, attachment will not involve covalent bond formation, but rather physical forces in which case the reactive group remains unaltered. By physical forces is meant attractive forces such as hydrogen bonding, electrostatic or ionic attraction, hydrophobic attraction such as base stacking, and specific affinity interactions such as biotin-streptavidin, antigen-antibody and nucleotide-nucleotide interactions.

Reactive groups for chemical binding of sensitizers or chemiluminescent compounds to organic and biological molecules include, but are not limited to, the following: a) Amine reactive groups: —N═C═S, —SO₂Cl, —N═C═O, —SO₂CH₂CF₃; b) Thiol reactive groups: —S—S—R; c) Carboxylic acid reactive groups: —NH2, —OH, —SH, —NHNH₂; d) Hydroxyl reactive groups: —N═C═S, —N═C═O, —SO2Cl, —SO₂CH₂CF₃; e) Aldehyde/ketone reactive groups: —NH2, —ONH₂, —NHNH₂; and f) Other reactive groups, e.g., R—N₃, R—C≡CH.

In one embodiment reactive groups include OH, NH₂, ONH₂, NHNH₂, COOH, SO₂CH₂CF₃, N-hydroxysuccinimide ester, N-hydroxysuccinimide ether and maleimide groups.

Bifunctional coupling reagents can also be used to couple labels to organic and biological molecules with moderately reactive groups (see L. J. Kricka, Ligand-Binder Assays, Marcel Dekker, Inc., New York, 1985, pp. 18-20, Table 2.2 and T. H Ji, “Bifunctional Reagents,” Methods in Enzymology, 91, 580-609 (1983)). There are two types of bifunctional reagents: those that become incorporated into the final structure, and those that do not and serve only to couple the two reactants.

### Aqueous Solutions

Aqueous solutions suitable for use in the present disclosure are generally solutions containing greater than 50% water. Aqueous solutions described herein are suitable for uses including reaction mixture, sample dilution, calibrator solutions, chemiluminescent-labeled sbp solutions, sensitizer-labeled sbp solutions, or concentrated solutions of one or more of: chemiluminescent-labeled sbp, sensitizer-labeled sbp, ancillary reagents, sample, and/or noise modulation agents. In many embodiments, aqueous solutions are aqueous buffer solutions. Suitable aqueous buffers include any of the commonly used buffers capable of maintaining an environment in aqueous solution maintaining analyte solubility, maintaining reactant solubility, and permitting the chemiluminescent reaction to proceed. Exemplary buffers include phosphate, borate, acetate, carbonate, tris(hydroxy-methylamino)methane (tris), glycine, tricine, 2-amino-2-methyl-1-propanol, diethanolamine MOPS, HEPES, MES and the like. Typically aqueous solutions for use according to the present disclosure will have a pH in the range of about 5 to about 10.5.

Suitable aqueous solutions may include one or more of the following additional components: salts, biological buffers, alcohols, including ethanol, methanol, glycols, and detergents. In some embodiments, aqueous solutions include Tris buffered aqueous solutions, such as Buffer 8 (TRIS buffered saline, surfactant, <0.1% sodium azide, and 0.1% ProClin® 300 (Rohm and Haas) available commercially from Beckman Coulter, Inc., Brea Calif.,).

In some embodiments, an aqueous solution emulating human serum is utilized. One such synthetic matrix is 20 mM PBS, 7% BSA, pH 7.5 with 0.1% ProClin® 300. Synthetic matrixes can be used for, but not limited to sample dilution, calibrator solutions, chemiluminescent-labeled sbp solutions, sensitizer-labeled sbp solutions, and ancillary reagents. The term “PBS” refers in the customary sense to phosphate buffered saline, as known in the art. The term “BSA” refers in the customary sense to bovine serum albumin, as known in the art.

### Assay Formats

Assay formats require a specific binding action to mediate the proximity between the chemiluminescent label of the chemiluminescent-labeled sbp and the sensitizer label of the sensitizer-labeled sbp.

In another embodiment an analog of the analyte is used comprising a sensitizer-analyte analog conjugate. In another embodiment a labeled analyte is used comprising a sensitizer-analyte conjugate. The sensitizer-analyte analog conjugate or sensitizer-analyte conjugate and analyte will competitively bind with the specific binding partner for the analyte. It will be apparent that in this type of assay method a negative correlation between the amount of analyte in the sample and the intensity of chemiluminescence will result.

In addition to attachment of chemiluminescent label through antibodies for binding antigens or other proteins or other antibodies via an immunoassay, the present methods can use chemiluminescent-labeled nucleic acids for detecting nucleic acids through binding of complementary nucleic acids. The use in this regard is not particularly limited with regard to the size of the nucleic acid, the only criterion being that the complementary partners be of sufficient length to permit stable hybridization. Nucleic acids as used herein include gene length nucleic acids, shorter fragments of nucleic acids, polynucleotides and oligonucleotides, any of which can be single or double stranded. In the practice of the disclosure using nucleic acids as specific binding partners, a nucleic acid is covalently attached or physically immobilized on a surface of a solid support to capture an analyte nucleic acid. The chemiluminescent label can be attached to the capture nucleic acid, or the label can be connected with an auxiliary substance, also attached to the capture nucleic acid as explained above. The capture nucleic acid will have full or substantially full sequence complementarity to a sequence region of the analyte nucleic acid. When substantially complementary, the capture nucleic acid may possess a terminal overhanging portion, a terminal loop portion or an internal loop portion that is not complementary to the analyte provided that it does not interfere with or prevent hybridization with the analyte. The reverse situation may also occur where the overhang or loop resides within the analyte nucleic acid. Capture nucleic acid, analyte nucleic acid, a conjugate of a sensitizer, and a third nucleic acid are allowed to hybridize. The third nucleic acid is substantially complementary to a sequence region of the analyte nucleic acid different from the region complementary to the capture nucleic acid. The hybridization of the capture nucleic acid and sensitizer conjugate nucleic acid with the analyte can be performed consecutively in either order or simultaneously. As a result of this process, the chemiluminescent label is brought into a reactive configuration with the sensitizer by virtue of specific hybridization reactions bringing the sensitizer near the chemiluminescent label attached to the surface of the support. Chemiluminescence is generated and detected as described above.

Another embodiment comprises a variation wherein a conjugate of the analyte with the sensitizer is used. The analyte nucleic acid-sensitizer conjugate and analyte nucleic acid will competitively bind with the specific binding partner for the analyte nucleic acid. It will be apparent that in this type of assay method a negative correlation between the amount of analyte in the sample and the intensity of chemiluminescence will result.

In addition to antibody-based and nucleic acid-based systems, other specific binding pairs as are generally known to one of ordinary skill in the art of binding assays can serve as the basis for test methods according to the present disclosure. Antibody-hapten pairs can also be used. Fluorescein/anti-fluorescein, digoxigenin/anti-digoxigenin, and nitrophenyl/anti-nitrophenyl pairs are exemplary.

### Detection

Light emitted by the present method can be detected by any suitable known means such as a luminometer, x-ray film, high speed photographic film, a CCD camera, a scintillation counter, a chemical actinometer or visually. Each detection means has a different spectral sensitivity. The human eye is optimally sensitive to green light, CCD cameras display maximum sensitivity to red light, X-ray films with maximum response to either UV to blue light or green light are available. Choice of the detection device will be governed by the application and considerations of cost, convenience, and whether creation of a permanent record is required. In those embodiments where the time course of light emission is rapid, it is advantageous to perform the signal generating reaction to produce the chemiluminescence in the presence of the detection device. As an example the detection reaction may be performed in a test tube or microwell plate housed in a luminometer or placed in front of a CCD camera in a housing adapted to receive test tubes or microwell plates.

### Uses

The present assay methods find applicability in many types of specific binding pair assays. Foremost among these are chemiluminescent enzyme linked immunoassays, such as an ELISA. Various assay formats and the protocols for performing the immunochemical steps are well known in the art and include both competitive assays and sandwich assays. Types of substances that can be assayed by immunoassay according to the present disclosure include proteins, peptides, antibodies, haptens, drugs, steroids and other substances that are generally known in the art of immunoassay.

The methods of the present disclosure are also useful for the detection of nucleic acids. In one embodiment a method makes use of enzyme-labeled nucleic acid probes. Exemplary methods include solution hybridization assays, DNA detection in Southern blotting, RNA by Northern blotting, DNA sequencing, DNA fingerprinting, colony hybridizations and plaque lifts, the conduct of which is well known to those of skill in the art.

### Kits

The present disclosure also contemplates providing kits for performing assays in accordance with the methods of the present disclosure.

In another embodiment of the present disclosure a kit is provided containing assay materials including chemiluminescent-labeled sbp, sensitizer-labeled sbp, noise modulation agent, and ancillary reagents. In some embodiments, these assay materials are provided in aqueous solution. In some embodiments, one or more of the assay materials are provided in concentrated aqueous solution. Concentrated aqueous solutions of the assay materials are provided to a reaction mixture in volumes to reach the desired final concentration of each assay material. In some embodiments, additional aqueous solution is provided for dilution of concentrated aqueous solutions. In other embodiments, one or more assay materials are provided in a lyophilized or solid form. In such embodiments, additional aqueous solution may be provided to convert the lyophilized or solid assay material into aqueous solution or aqueous solution concentrate.

In some kit embodiments, each assay material is provided in a separate container. In other kit embodiments, one or more assay materials are provided in a common container. In still other kit embodiments, one or more assay materials are provided in a common container divided in wells wherein each well holds an assay material.

Kits may comprise, in packaged combination, noise modulation agent, chemiluminescent labels as either the free labeling compounds, chemiluminescent labeled specific binding partners, or chemiluminescent labeled auxiliary substances such as blocking proteins, along with any required ancillary reagents and instructions for use. Kits may optionally also contain sensitizer conjugates, analyte calibrators and controls, diluents and reaction buffers if chemiluminescent labeling is to be performed by the user.

### Instrument

The assay methods described in the present disclosure may be automated for rapid performance by employing a system. A system for performing assays of the present disclosure requires the fluid handling capabilities for aliquoting and delivering reagents to a reaction vessel containing the sample and reading the resulting chemiluminescent signal. In embodiments wherein a photosensitizer is used to generate singlet oxygen, a light source, preferably a laser is employed. Optical filter elements may be provided for wavelength discrimination of the irradiating and emitted chemiluminescent light. Representative instruments for performing the present assay include the Dimension Vista 500 (Siemens Healthcare Diagnostics, Deerfield, Ill.) or the Paradigm® platform (Beckman Coulter, Brea, Calif.). In embodiments of such a system, a luminometer is positioned proximal to the reaction vessel at the time and place of signal generation. Preferably, the detection system including luminometer or other detection device acts in concert with the fluid handling system. Additionally, an automated system for performing assays of the present disclosure has fluid handling capabilities for aliquoting and delivering the other reactants and sample to a reaction vessel. In an embodiment, a system for performing the assay method of the present invention includes a fluid handling system for delivery of sample into the reaction mixture, a fluid handling system for delivery of a chemiluminescent-labeled specific binding partner, a sensitizer-labeled specific binding partner, noise modulation agent into the reaction mixture, and a light source; and a detection system to detect the chemiluminescent signal, wherein the a fluid handling system and light source act in concert with the detection system to measure the chemiluminescent signal releases at and following irradiation.

### EXAMPLES

### Example 1

This example demonstrates an immunoassay for an analyte using a method described in the present disclosure. The effect of adding a noise modulation agent on the signal strength and signal sensitivity of an assay for an analyte is demonstrated.

Sample solutions containing 0 or 100 ng/mL of PSA in 1× AlphaLISA Immunoassay Buffer (PerkinElmer) were prepared from 1 mg/mL stock solution of PSA from seminal fluid. Five μL aliquots of the sample were added to wells of a 96-well microtiter plate (Greiner Bio-One, Monroe N.C.). Twenty μL of biotinylated anti-PSA antibody at a concentration of 30 μg/mL were added to each well, along with AlphaLISA acceptor beads (PerkinElmer) at a concentration of 1000 μg/mL. The mixture was incubated for one hour at room temperature. Twenty five μL of streptavidin-coated donor beads (PerkinElmer) were added to each well, followed by incubation for 30 minutes at room temperature and in the dark. After incubation, 10 μL of sodium azide solution, the singlet oxygen quencher (SOQ), prepared at concentrations of 0.01, 0.1, 1, 10 and 100 mM in water, were added to each well and mixed, with water used as a control. Chemiluminescence was generated by excitation at 680 nm for 40 milliseconds. The chemiluminescent flash was integrated 80 milliseconds and read using the Paradigm platform (Beckman-Coulter) at a wavelength of 570 nm. The microtiter plate was re-read with longer cycle time, i.e. excitation for 180 milliseconds and 550 millisecond integration.

The data provided in Table 2 shows signal-to-noise ratios for a standard immunoassay for PSA, using different concentrations of either ascorbic acid or sodium azide as the noise modulation agent. At 40 millisecond excitation and 80 millisecond integration, sodium azide is an effective singlet oxygen quencher (SOQ), with signal-to-noise ratios for a standard immunoassay for PSA increased by as much as 20%, whereas ascorbic acid used at the same concentrations did not show significant increase in signal-to-noise. The increase in non-specific signal caused by generation of large quantities of singlet oxygen is reduced when sodium azide is added, because the azide quenches the singlet oxygen and thereby significantly reduces the non-specific signal in an assay.

Table 3 shows data for the same immunoassay, with the plate re-read at 180 millisecond excitation and 550 millisecond integration. As seen in the table, use of a SOQ improved the signal-to-noise improved by as much as 37%.

TABLE 1
Plate were read initially using 40 msec excitation time/
80 msec integration time followed by a another reading
using 180 msec excitation time/550 msec integration time
40 msec excitation
80 msec integration

| | | | | | % improve- |
|---|---|---|---|---|---|
| Final Conc | PSA | mean | | | ment |
| in Rxn | (ng/mL) | RFU | CV | S/N | in S/N |
| DiH2O Control | 0 | 6,158 | 7% | | |
| | 100 | 569,102 | 8% | 92.4 | |
| 16.7 mM | 0 | 1,068 | 24% | | |
| Ascorbic Acid | 100 | 17,691 | 2.4% | 16.6 | |
| 1.67 mM | 0 | 2,650 | 4% | | |
| Ascorbic Acid | 100 | 258,099 | 34% | 97.4 | |
| 0.167 mM | 0 | 5,034 | 9% | | |
| Ascorbic Acid | 100 | 448,097 | 9.8% | 89.0 | |
| 16.7 mM | 0 | 682 | 3% | | |
| (0.11%)NaN3 | 100 | 3,185 | 10% | 4.7 | |
| 1.67 mM | 0 | 1,301 | 0% | | |
| (0.011%)NaN3 | 100 | 144,827 | 14.5% | 111.4 | 20% |
| 0.167 mM | 0 | 4,349 | 3% | | |
| (0.0011%)NaN3 | 100 | 407,238 | 8% | 93.6 | |
| 0.0167 mM | 0 | 5,911 | 12% | | |
| (0.00011%)NaN3 | 100 | 468,783 | 2.6% | 79.3 | |

TABLE 2
180 msec excitation
550 msec integration

| | | | | | % improve- |
|---|---|---|---|---|---|
| Final Conc | PSA | mean | | | ment |
| in Rxn | (ng/mL) | RFU | CV | S/N | in S/N |
| DiH2O Control | 0 | 114,353 | 2% | | |
| | 100 | 6,577,428 | 7% | 57.5 | |
| 16.7 mM | 0 | 26,323 | 7% | | |
| Ascorbic Acid | 100 | 141,201 | 9.7% | 5.4 | |
| 1.67 mM | 0 | 36,052 | 2% | | |
| Ascorbic Acid | 100 | 2,112,440 | 16% | 58.6 | |
| 0.167 mM | 0 | 86,834 | 3% | | |
| Ascorbic Acid | 100 | 5,085,068 | 9.1% | 58.6 | |
| 16.7 mM | 0 | 4,811 | 6% | | |
| (0.11%)NaN3 | 100 | 38,340 | 1% | 8.0 | |
| 1.67 mM | 0 | 23,950 | 0% | | |
| (0.011%)NaN3 | 100 | 1,884,116 | 6.8% | 78.7 | 37% |
| 0.167 mM | 0 | 82,314 | 1% | | |
| (0.0011%)NaN3 | 100 | 4,899,798 | 4% | 59.5 | |
| 0.0167 mM | 0 | 101,999 | 5% | | |
| (0.00011%)NaN3 | 100 | 6,102,933 | 5.0% | 59.8 | |

1-11. (canceled)

12. A method for determining the presence of an analyte in a sample suspected of containing said analyte, the method comprising:
a) forming a reaction mixture comprising the sample, a first substance that can produce a metastable species, and a second substance that can react with the metastable species to produce a detectable signal, by combining at least the sample and the first and second substances;
b) treating the reaction mixture with energy or a reactive compound to cause the first substance to form a metastable species,
wherein the analyte, if present, either i) brings the second substance into close proximity to the site of formation of the metastable species, or ii) blocks the second substance from coming into close proximity of the site of formation of the metastable species;
c) adding a selective signal inhibiting agent that interferes with the reaction of any metastable species not in close proximity to the second substance; and
d) determining whether the metastable species has reacted with the second substance by detecting a signal produced by the second substance as a result of activation of the second substance by the metastable species, the presence or amount of the signal indicating the presence of analyte in the sample.

13. The method of claim 12, wherein the metastable species comprises singlet oxygen, triplet states, dioxetanes or dioxetane diones.

14. The method of claim 13, wherein the metastable species has a lifetime of less than 1 ms.

15. The method of claim 12, wherein the selective signal inhibiting agent is a singlet oxygen quencher or free radical trap.

16. The method of claim 15, wherein the selective signal inhibiting agent comprises ascorbic acid, tocopherol, vitamin D, beta-carotene, thioredoxin, lidocaine, sodium azide, manganese (II) chloride, copper (II) chloride, platinum (II) colloids, tertiary amines, dienes, conjugated polyenes, electron-rich alkenes, guanine, TEMP, proline, or mixtures thereof.

17. The method of claim 12, wherein the reaction of the metastable species with the second substance results in chemiluminescence.

18. The method of claim 12, further comprising determining the amount or concentration of the analyte in the sample.

19. The method of claim 12 wherein the second substance is a chemiluminescent compound and wherein the first substance is a photosensitizer compound.

20. The method of claim 19 wherein the chemiluminescent compound is conjugated to a first specific binding partner is associated with a first suspendible particle and wherein the sensitizer compound conjugated to the second specific binding partner is associated with a second suspendible particle.

21. The method of claim 20 wherein the chemiluminescent compound conjugated to the first specific binding partner is associated with a first suspendible particle and wherein the sensitizer compound conjugated to the second specific binding partner is associated with a second suspendible particle.

22. A method for increasing the sensitivity of an assay of an analyte in a sample, the method comprising:
forming a reaction mixture, in any order or concurrently, by adding the sample,
a chemiluminescent-labeled specific binding partner,
a sensitizer-labeled specific binding partner, and
a selective signal inhibiting agent,
to form a binding complex;
treating the reaction mixture with energy or a reactive compound to cause the sensitizer-labeled specific binding partner to form a metastable species,
wherein the analyte, if present, either i) brings the chemiluminescent-labeled specific binding partner into close proximity to the site of formation of the metastable species, or ii) blocks the chemiluminescent-labeled specific binding partner from coming into close proximity to the site of formation of the metastable species;
wherein the interaction of the metastable species with the binding complex releases a detectable chemiluminescent signal correlated to the amount of analyte in the reaction mixture, and
wherein the selective signal inhibiting agent interferes with excess metastable species that has not interacted with the binding complex and thereby reduces non-specific signal and increases sensitivity of the assay.

23. A kit for detecting an analyte in a sample, the kit comprising:
a first specific binding partner for the analyte;
a chemiluminescent compound conjugated to the first specific binding partner;
a second specific binding partner;
a sensitizer compound conjugated to the second specific binding partner; and
a selective signal inhibiting agent.

24. The kit of claim 23, wherein the selective signal inhibiting agent is a singlet oxygen quencher or free radical trap.

25. The kit of claim 23, wherein the selective signal inhibiting agent comprises ascorbic acid, tocopherol, vitamin D, beta-carotene, thioredoxin, lidocaine, sodium azide, manganese (II) chloride, copper (II) chloride, platinum (II) colloids, tertiary amines, dienes, conjugated polyenes, electron-rich alkenes, guanine, TEMP, proline, or mixtures thereof.

26. The kit of claim 23, wherein the sensitizer is a photosensitizer capable upon irradiation with light of generating singlet oxygen.

27. The kit of claim 26 wherein chemiluminescent compound conjugated to the first specific binding partner is associated with a first suspendible particle and wherein the sensitizer compound conjugated to the second specific binding partner is associated with a second suspendible particle.
